(19) United States
(12) Patent Application Publication
(10) Pub. No.: US 2020/0017745 A1
(43) Pub. Date: Jan. 16, 2020

(54) ANTI-FREEZE ANTI-CORROSION CONCENTRATES

(71) Applicant: BASF SE, Ludwigshafen am Rhein (DE)

(72) Inventors: Harald DIETL, Ludwigshafen (DE); Nicolas VAUTRAVERS, Ludwigshafen (DE); Henning ALTHOEFER, Ludwigshafen (DE)

(73) Assignee: BASF SE, Ludwigshafen am Rhein (DE)

(21) Appl. No.: 16/495,620

(22) PCT Filed: Mar. 6, 2018
(86) PCT No.: PCT/EP2018/055460

§ 371 Date: Sep. 19, 2019

(30) Foreign Application Priority Data
Mar. 21, 2017 (EP) 17161949.7
Mar. 21, 2017 (EP) 17161965.3

(51) Int. Cl. C09K 5/20; C23F 11/12; C23F 11/14; C23F 11/18

(52) U.S. Cl. CPC C09K 5/20; C23F 11/126; C23F 11/122; C23F 11/143; C23F 11/188; C23F 11/149; C23F 11/181; C23F 11/182; C23F 11/145

(57) ABSTRACT

The present invention relates to antifreeze/anticorrosive concentrates, to processes for production of such concentrates from superconcentrates, to aqueous coolant compositions made from these concentrates and to the use thereof.

The present invention relates to antifreeze/anticorrosive concentrates, to processes for production of such concentrates from superconcentrates, to aqueous coolant compositions made from these concentrates, and to the use thereof.

Coolant compositions for the cooling circuits of internal combustion engines of automobiles, for example, usually comprise alkylene glycols, mainly ethylene glycol and/or propylene glycol, as the antifreeze component.

In addition to further components, corrosion inhibitors in particular are present.

Modern internal combustion engines in particular attain thermal stresses which place high demands on the materials used. Any type and any extent of corrosion constitute a potential risk factor which can lead to a shortening in the lifetime of the engine and to a reduction in reliability. In addition, a multitude of different materials is increasingly being used in modern engines, for example cast iron, copper, brass, soft solder, steel, and magnesium and aluminum alloys. This multitude of metallic materials results additionally in potential corrosion problems, especially at the points at which different metals are in contact with one another. Especially at these points, a wide variety of different types of corrosion may occur comparatively readily, for example pitting corrosion, crevice corrosion, erosion or cavitation.

The coolant compositions likewise have to be compatible with nonmetallic constituents of the cooling circuit as well, for example elastomers and plastics from hose connections or seals, and must not alter them.

Furthermore, the coolant composition is of crucial importance in heat transfer in modern internal combustion engines.

As well as coolant containers which already comprise the ready-to-use coolant compositions mentioned, antifreeze/anticorrosion concentrates are becoming ever more important. It is necessary merely to add water to these concentrates in order to obtain the ready-to-use coolant compositions.

Antifreeze/anticorrosion concentrates thus likewise comprise components which firstly serve to prevent freezing, i.e. for freezing point depression of the mixture, and secondly corrosion inhibitors which serve to prevent corrosion. The proportion of the anticorrosion component in the concentrate is typically up to 10% by weight based on the total amount of the concentrate. The proportion of the concentrate in the ready-to-fill radiator protectant is typically 10 to 60% by weight. Concentrates may already comprise small amounts of water; they are preferably anhydrous.

Especially for transport reasons, superconcentrates which have a reduced amount of antifreeze component, i.e. usually and preferably ethylene glycol, but also 1,2-propylene glycol and/or glycerol instead or in addition, are additionally obtainable in order to provide a very compact container. In this case, the amount of antifreeze component removed from a concentrate is usually such that the further constituents just remain in dissolved form.

Antifreeze/anticorrosion concentrates are therefore obtainable from superconcentrates by mixing in a certain amount of antifreeze component and optionally a little water. The proportion of the superconcentrate in the concentrate is typically 3% to 60% by weight.

As mentioned above, alkylene glycols, mainly ethylene glycol and/or propylene glycol, usually form the main constituents of the antifreeze component.

The corrosion inhibitors which serve as the antifreeze component are known in the prior art. Antifreezes comprising carboxylic acids, molybdates and triazoles are known from EP-B 552 988 or U.S. Pat. No. 4,561,990.

EP-B 229 440 describes an anticorrosion component composed of an aliphatic monobasic acid, a dibasic hydrocarbyl acid and a hydrocarbyl triazole.

Specific acids as an anticorrosion component are described in EP-B 479 470. Quaternized imidazoles are disclosed in DE-A 196 05 509.

For a polyethylene glycol acid having molecular weight 600, Y. Ein-Eli in Electrochemical and Solid-State Letters, 7 (1) B5-B7 (2004) reports inhibition of the corrosive action against zinc. What is not disclosed is the use thereof against other metals or in antifreezes.

WO 2014/124826 discloses antifreezes and concentrates thereof that result in only minor corrosion of aluminum materials, particularly those that have been produced using a soldering method with a fluoroaluminate flux. In particular, sebacic acid, which is frequently used industrially, is used here as anticorrosive.

A disadvantage of the use of sebacic acid in antifreezes is its low solubility in the typical media (only about 1 g/L in water 20° C.) and the difficulty of preparation thereof.

The corrosion protection achieved with the mixtures and concentrates known to date, and also the freezing points achievable, are generally good. Nevertheless, owing to ever increased performance of new internal combustion engines, there is a constant need for improved antifreeze/anticorrosion concentrates, especially for substitutes for sebacic acid which have similarly good anticorrosive action and have higher solubility in the antifreeze.

Diglycolic acid has long been commercially available (see, for example, W. M. Bruner et al., Industrial and Engineering Chemistry, Aug. 1, 1949, pages 1653-1656) and, according to A. A. Roscher et al., The Bulletin Society of Pharmacological and Environmental Pathologists, Vol. III, No. 4, December 1975, is used as detergent component for cooling systems in automobiles and as complexing agent for calcium and iron. According to A. A. Roscher et al., a disadvantage of diglycolic acid is its toxicity.

It is an object of the present invention to provide such antifreeze/anticorrosion concentrates which do not have the disadvantages of the prior art or at least have them in reduced form. These mixtures are to have a balanced ratio of the corrosion protection, heat transfer and frost resistance properties.

The object is achieved by an antifreeze/anticorrosive concentrate comprising 1% to 10% by weight, preferably 2% to 8% by weight and more preferably 3% to 7% by weight, based on the total amount of the concentrate, of a mixture of

30-100% by weight of

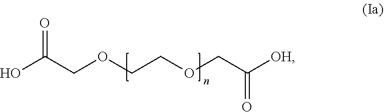

0-40% by weight of

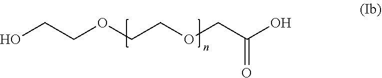

and
0-30% by weight of

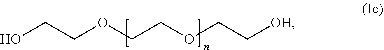

in which n is a positive integer from 1 to 5 and may be the same or different for each of the compounds (Ia), (Ib) and (Ic),
with the proviso that the sum total of the amounts of compounds (Ia), (Ib) and (Ic) in the mixture is always 100% by weight.

This is because it has been found that the use of compound (Ia), optionally in conjunction with component (Ib) and/or (Ic), in the concentrate can achieve improved properties of the anticorrosion concentrate, particularly with regard to corrosion protection. Compound (Ia) shows a comparably good anticorrosive effect to sebacic acid and is readily soluble in water.

Preferably, the amount of the mixture is 2% to 8% by weight, especially preferably 3% to 7% by weight, based on the total amount of the antifreeze or anticorrosion concentrate.

The mixture is a mixture of compound (Ia), optionally in combination with compound (Ib) and/or (Ic), which is generally of the following composition:

(Ia) 30-100% by weight, preferably 50-100%, more preferably 60-99.7%, even more preferably 70-99.9% and especially 80-99% by weight,
(Ib) 0-40% by weight, preferably 0-30%, more preferably 0.05-25%, even more preferably 0.1-20% and especially 0.2-15% by weight, and
(Ic) 0-30% by weight, preferably 0-20%, more preferably 0-15%, even more preferably 0.05-10% and especially 0.1-5% by weight,
with the proviso that the sum total of the amounts of compounds (Ia), (Ib) and (Ic) in the mixture is always 100% by weight.

In a preferred embodiment, the mixture is essentially free of compound (Ic).

In a further preferred embodiment, the mixture is additionally essentially free of compound (Ib).

In the formulae of compounds (Ia), (Ib) and (Ic), the serial number “n” may be a positive integer from 1 to 5, preferably 1 to 4, more preferably 1 to 3 and most preferably 1 or 2.

It should be noted that the compounds of the formula (Ia), (Ib) and (Ic) are reaction mixtures having a distribution of the product composition according to the reaction conditions. For instance, the chain length distribution is subject to a distribution about a statistical average, which may be distributed about a statistical average n. Thus, while the value of n for each individual compound of the formula (Ia), (Ib) and (Ic) assumes positive integer numbers, it can also assume non-integer values on statistical average for the reaction mixture.

The mixture of compounds (Ia), optionally in combination with (Ib) and/or (Ic), may preferably be wholly or partly in the form of the alkali metal salts thereof. Preferably, the compounds are wholly or partly in the form of their sodium or potassium salts, more preferably in the form of their potassium salts.

The neutralization level is preferably at least 75%, more preferably at least 85%, even more preferably at least 95% and especially at least 99%.

The serial number “n” may be the same or different for each of the compounds (Ia), (Ib) and (Ic). Since the compounds (Ia) are preferably prepared from the compounds (Ic) by oxidation (see below) and this oxidation may be associated with a degradation of the polymeric chains, it is a preferred embodiment that the serial number “n” for compounds (Ia) on arithmetic average may be up to 1.5 less than the compounds (Ic) in the mixture, preferably up to 1 less, more preferably up to 0.8 less, even more preferably up to 0.7 and especially up 0.6 less.

In an analogous manner, the serial number “n” for compounds (Ib) on arithmetic average may be up to 1 less than for the compounds (Ic) in the mixture, preferably up to 0.8 less, more preferably of 0.7 less, even more preferably of 0.6 and especially of 0.5 less.

The mixtures of the compounds (Ia), optionally in combination with (Ib) and/or (Ic), can be prepared by methods known per se to those skilled in the art, preferably from compounds (Ic).

The starting material used is generally compound (Ic), and this is oxidized in the presence of suitable catalysts and in the presence of oxygenous gases or pure oxygen, for example as described in U.S. Pat. No. 4,256,916, in K. Heidkamp et al., Catalysis Science & Technology, 3(11), 2984-2992; 2013 or in analogy to DE 2936123. Also conceivable are methods in which oxidation is effected with nitrogen oxides.

Preferably, compound (Ia) is prepared in an oxidation process from compound (Ic) in which the serial number “n” is reduced to a minimum degree, more preferably by not more than 1, even more preferably by not more than 0.7 and especially by not more than 0.5.

As well as the mixture of compounds (Ia), optionally in combination with (Ib) and/or (Ic), the antifreeze/anticorrosion concentrate additionally generally comprises at least one alcohol as antifreeze component.

It is additionally possible here for alcohol to be selected from monohydric, dihydric, trihydric alcohols, polyhydroxy alcohols, ethers thereof or mixtures thereof to be present as antifreeze component.

Additional alcohols may be selected from the group consisting of ethylene glycol, 1,2-propylene glycol, diethylene glycol, dipropylene glycol, triethylene glycol, tetraethylene glycol, pentaethylene glycol, hexaethylene glycol, dipropylene glycol, tripropylene glycol, tetrapropylene glycol, pentapropylene glycol, hexapropylene glycol, 1,3-propylene glycol, glycerol, monoethers of glycols such as the methyl, ethyl, propyl and butyl ethers of ethylene glycol, propylene glycol, diethylene glycol and dipropylene glycol. Preferably, the additional alcohols are selected from the group consisting of ethylene glycol, diethylene glycol, propylene glycol, dipropylene glycol and glycerol. More preferably, they are selected from the group consisting of ethylene glycol, propylene glycol and glycerol; very particular preference is given to ethylene glycol.

The alcohol used is preferably an alcohol other than an alcohol of the formula (Ic).

In the context of the present invention, unless explicitly stated otherwise, the term “propylene glycol” is understood to mean propane-1,2-diol.

The amount of at least one further corrosion inhibitor as anticorrosion component in addition to the amount of antifreeze component and the mixture of components (Ia) and optionally (Ib) and/or (Ic) is preferably 0.01% to 5% by weight, based on the total amount of the concentrate.

More preferably, the amount is 0.1% to 4% by weight, especially preferably 0.5% to 3% by weight.

Accordingly, a preferred embodiment of the present invention is an antifreeze/anticorrosive concentrate comprising 1% to 10% by weight, preferably 2% to 8% by weight and more preferably 3% to 7% by weight, based on the total amount of the concentrate, of a mixture of

30-100% by weight of

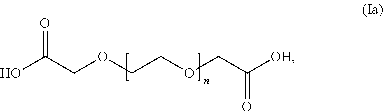

0-40% by weight of

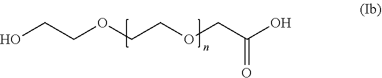

and
0-30% by weight of

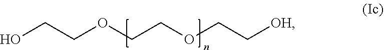

in which n is a positive integer from 1 to 5 and may be the same or different for each of the compounds (Ia), (Ib) and (Ic),
with the proviso that the sum total of the amounts of compounds (Ia), (Ib) and (Ic) in the mixture is always 100% by weight,
and additionally 0.01% to 5% by weight, based on the total amount of the concentrate, preferably 0.1% to 4% by weight and more preferably 0.5% to 3% by weight of at least one corrosion inhibitor other than the compounds (Ia), (Ib) and (Ic).

A further preferred embodiment of the present invention is an antifreeze/anticorrosive concentrate consisting of 1% to 10% by weight, preferably 2% to 8% by weight and more preferably 3% to 7% by weight, based on the total amount of the concentrate, of a mixture of

30-100% by weight of

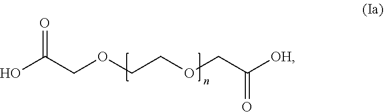

0-40% by weight of

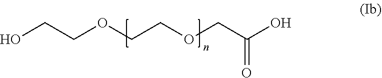

and
0-30% by weight of

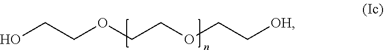

in which n is a positive integer from 1 to 5 and may be the same or different for each of the compounds (Ia), (Ib) and (Ic),
with the proviso that the sum total of the amounts of compounds (Ia), (Ib) and (Ic) in the mixture is always 100% by weight,
and additionally 0.01% to 5% by weight, based on the total amount of the concentrate, preferably 0.1% to 4% by weight and more preferably 0.5% to 3% by weight of at least one corrosion inhibitor other than the compounds (Ia), (Ib) and (Ic),
optionally one or more further typical ingredients of antifreeze/anticorrosive concentrates
and additionally the difference from 100% by weight, based on the total amount of the concentrate, of at least one alcohol as antifreeze component, preferably selected from the group consisting of ethylene glycol, 1,2-propylene glycol, diethylene glycol, dipropylene glycol, triethylene glycol, tetraethylene glycol, pentaethylene glycol, hexaethylene glycol, dipropylene glycol, tripropylene glycol, tetrapropylene glycol, pentapropylene glycol, hexapropylene glycol, 1,3-propylene glycol, glycerol, monomethyl-, -ethyl-, -propyl- and -butyl ethers of ethylene glycol, propylene glycol, diethylene glycol and dipropylene glycol, more preferably selected from the group consisting of ethylene glycol, diethylene glycol, propylene glycol, dipropylene glycol and glycerol, most preferably ethylene glycol, propylene glycol and glycerol and especially ethylene glycol.

In a preferred embodiment, an antifreeze/anticorrosion concentrate according to the present invention, as well as the mixture and at least one antifreeze component, may optionally additionally comprise at least one of the following components as typical ingredients of antifreeze/anticorrosion concentrates in an amount specified in each case, based on the total amount of the concentrate:

(a) up to 5% by weight of one or more aliphatic, cycloaliphatic or aromatic monocarboxylic acids each having 3 to 16 carbon atoms in the form of their alkali metal, ammonium or substituted ammonium salts;
(b) up to 5% by weight of one or more aliphatic or aromatic di- or tricarboxylic acids each having 3 to 21 carbon atoms in the form of their alkali metal, ammonium or substituted ammonium salts;
(c) up to 1% by weight of one or more alkali metal borates, alkali metal phosphates, alkali metal silicates, alkali metal nitrites, alkali metal or alkaline earth metal nitrates, alkali metal molybdates or alkali metal or alkaline earth metal fluorides;
(d) up to 5% by weight of one or more aliphatic, cycloaliphatic or aromatic amines which have 2 to 15 carbon atoms and may additionally comprise ether oxygen atoms or hydroxyl groups;
(e) up to 5% by weight of one or more mono- or polycyclic, unsaturated or partly unsaturated heterocycles which have 4 to 10 carbon atoms and may be benzofused and/or may bear additional functional groups;
(f) up to 5% by weight of one or more tetra(C₁-C₈-alkoxy)silanes (tetra-C₁-C₈-alkyl orthosilicates);
(g) up to 10% by weight of one or more carboxamides or sulfonamides;
(h) up to 1% by weight of one or more hard water stabilizers based on polyacrylic acid, polymaleic acid, acrylic acid-maleic acid copolymers, polyvinylpyrrolidone, polyvinylimidazole, vinylpyrrolidone-vinylimidazole copolymers and/or copolymers of unsaturated carboxylic acids and olefins.

The compounds of groups a) to g) are generally corrosion inhibitors.

Useful linear or branched-chain, aliphatic or cycloaliphatic monocarboxylic acids (a) are, for example, propionic acid, pentanoic acid, hexanoic acid, cyclohexyl acetic acid, octanoic acid, 2 ethylhexanoic acid, nonanoic acid, isononanoic acid, decanoic acid, 2-propylheptanoic acid, undecanoic acid or dodecanoic acid. A suitable aromatic monocarboxylic acid (a) is in particular benzoic acid; additionally useful are also, for example, Cᵣ to C₈-alkylbenzoic acids such as o-, m-, p-methylbenzoic acid, and hydroxyl-containing aromatic monocarboxylic acids such as o-, m- or p-hydroxybenzoic acid, o-, m- or p-(hydroxymethyl)benzoic acid or halobenzoic acids such as o-, m- or p-fluorobenzoic acid.

Typical examples of di or tricarboxylic acids (b) are malonic acid, succinic acid, glutaric acid, adipic acid, pimelic acid, suberic acid, azelaic acid, sebacic acid, undecanedioic acid, dodecanedioic acid, dicyclopentadienedicarboxylic acid, phthalic acid, terephthalic acid and triazinetriiminocarboxylic acids such as 6,6′,6″-(1,3,5-triazine-2,4,6-triyltriimino)trihexanoic acid.

All these carboxylic acids of groups (a) and (b) are in the form of alkali metal salts, in particular in the form of sodium or potassium salts, or in the form of ammonium salts or substituted ammonium salts (amine salts), for example with ammonia, trialkylamines or trialkanolamines.

Typical examples of corrosion inhibitors mentioned under (c) are sodium tetraborate (borax), disodium hydrogenphosphate, trisodium phosphate, sodium metasilicate, sodium nitrite, sodium nitrate, magnesium nitrate, sodium fluoride, potassium fluoride, magnesium fluoride and sodium molybdate.

When alkali metal silicates are used as well, they are appropriately stabilized by customary organosilicophosphonates or organosilicosulfonates in customary amounts.

Useful aliphatic, cycloaliphatic or aromatic amines (d) having 2 to 15, preferably 4 to 8 carbon atoms, which may additionally comprise ether oxygen atoms, especially 1 to 3 ether oxygen atoms, or hydroxyl groups, especially 1 to 3 hydroxyl groups, are, for example, ethylamine, propylamine, isopropylamine, n-butylamine, isobutylamine, sec-butylamine, tert-butylamine, n-pentylamine, n-hexylamine, n-heptylamine, n-octylamine, isononylamine, di-n-propylamine, diisopropylamine, di-n-butylamine, mono-, di- and triethanolamine, piperidine, morpholine, aniline or benzylamine. Aliphatic and cycloaliphatic amines (d) are generally saturated.

Also conceivable are ethoxylated alkylamines, preferably those that bear at least one straight-chain or branched C₃-C₂₀-alkyl chain, preferably C₆-C₁₃-alkyl chain, more preferably C₇-C₁₂-alkyl chain and especially preferably C₈-C₁₁-alkyl chain.

The ethoxylation level may be from 1 to 35 ethylene oxide groups per alkylamine, preferably from 1.5 to 15, more preferably from 1.8 to 9 and especially from 2 to 6.

Preferred amines are n-propylamine, isopropylamine, n-butylamine, isobutylamine, sec-butylamine, tert-butylamine, n-pentylamine, tert-pentylamine, n-hexylamine, n-heptylamine, n-octylamine, 2-ethylhexylamine, n-nonylamine, n-decylamine, 2-propylheptylamine, n-undecylamine, n-dodecylamine, n-tridecylamine, isotridecylamine, n-tetradecylamine, n-pentadecylamine, n-hexadecylamine, n-heptadecylamine, n-octadecylamine, n-nonadecylamine, n-eicosylamine, di(n-hexyl)amine, di(n-heptyl)amine, di(n-octyl)amine, di(2-ethylhexyl)amine, di(n-nonyl)amine, di(n-decyl)amine, di(2-propylheptyl)amine, di(n-undecyl)amine, di(n-dodecyl)amine, di(n-tridecyl)amine, di(isotridecyl)amine, di(n-tetradecyl)amine, di(n-pentadecyl)amine, di(n-hexadecyl)amine, di(n-heptadecyl)amine, di(n-octadecyl)amine, di(n-nonadecyl)amine, di(n-eicosyl)amine, n-hexylmethylamine, n-heptylmethylamine, n-octylmethylamine, (2-ethylhexyl)methylamine, n-nonylmethylamine, n-decylmethylamine, (2-propylheptyl)methylamine, n-undecylmethylamine, n-dodecylmethylamine, n-tridecylmethylamine, isotridecylmethylamine, n-tetradecylmethylamine, n-pentadecylmethylamine, n-hexadecylmethylamine, n-heptadecylmethylamine, n-octadecylmethylamine, n-nonadecylmethylamine and n-eicosylmethylamine.

Preference is given to diethoxylated stearylamine, oleylamine, tallamine or octylamine, particular preference to ethoxylated octylamine.

The heterocycles (e) are, for example, monocyclic five- or six-membered systems having 1, 2 or 3 nitrogen atoms or having one nitrogen atom and one sulfur atom, which may be benzofused. It is also possible to use bicyclic systems composed of five- and/or six-membered rings having typically 2, 3 or 4 nitrogen atoms.

The heterocycles (e) may additionally bear functional groups, preferably C1-C4-alkoxy, amino and/or mercapto. The basic heterocyclic skeleton may of course also bear alkyl groups, in particular C₁-C₄-alkyl groups.

Typical examples of heterocycles (e) are benzotriazole, tolutriazole (tolyltriazole), hydrogenated tolutriazole, 1H-1,2,4-triazole, benzimidazole, benzothiazole, adenine, purine, 6 methoxypurine, indole, isoindole, isoindoline, pyridine, pyrimidine, 3,4 diaminopyridine, 2 aminopyrimidine and 2 mercaptopyrimidine.

Useful examples of the tetra(C₁-C₈-alkoxy)silanes (f) are tetramethoxysilane, tetraethoxysilane, tetra-n-propoxysilane or tetra-n-butoxysilane.

The amides (g) may optionally be alkyl-substituted on the nitrogen atom of the amide group, for example by a C₁-C₄-alkyl group. Basic aromatic or heteroaromatic skeletons of the molecule may of course also bear such alkyl groups. There may be one or more, preferably one or two, amide groups present in the molecule. The amides may bear additional functional groups, preferably C₁-C₄-alkoxy, amino, chlorine, fluorine, hydroxyl and/or acetyl; in particular, such functional groups are present as substituents on aromatic or heteroaromatic rings present.

Typical examples of such carboxamides and sulfonamides of group (g) are listed in DE-A 100 36 031

In particular, typical examples of such carboxamides and sulfonamides of group (g) are listed below.
aromatic carboxamides:
   benzamide, 2-methylbenzamide, 3-methylbenzamide, 4-methylbenzamide, 2,4-dimethylbenzamide, 4-tert-butylbenzamide, 3-methoxybenzamide, 4-methoxybenzamide, 2-aminobenzamide (anthranilamide), 3-aminobenzamide, 4-aminobenzamide, 3-amino-4-methylbenzamide, 2-chlorobenzamide, 3-chlorobenzamide, 4-chlorobenzamide, 2-fluorobenzamide, 3-fluorobenzamide, 4-fluorobenzamide, 2,6-difluorobenzamide, 4-hydroxybenzamide, phthalamide, terephthalamide;
heteroaromatic carboxamides:
   nicotinamide (pyridine-3-carboxamide), picolinamide (pyridine-2-carboxamide);
aliphatic carboxamides:
   succinamide, adipamide, propionamide, hexanamide;
cycloaliphatic carboxamides having the amide moiety as a constituent of the ring:
   2-pyrrolidone, N-methyl-2-pyrrolidone, 2-piperidone, ε-caprolactam;
aliphatic sulfonamides:
   methanesulfonamide, hexane-1-sulfonamide;
aromatic sulfonamides:
   benzenesulfonamide, o-toluenesulfonamide, m-toluenesulfonamide, p-toluenesulfonamide, 4-tert-butylbenzenesulfonamide, 4-fluorobenzenesulfonamide, 4-hydroxybenzenesulfonamide, 2-aminobenzenesulfonamide, 3-aminobenzenesulfonamide, 4-aminobenzenesulfonamide, 4-acetylbenzenesulfonamide.

In addition to this anticorrosion component of groups (a) to (g), it is also possible to use, for example, soluble magnesium salts of organic acids, for example magnesium benzenesulfonate, magnesium ethanesulfonate, magnesium acetate or magnesium propionate, hydrocarbazoles or quaternized imidazoles, as described in DE-A 196 05 509, in customary amounts as further inhibitors.

Of the above-listed additional ingredients of the inventive antifreeze/anticorrosion concentrates, preference is given to additionally using carboxylic acids of groups (a) and/or (b) and/or heterocycles of group (e).

In a particularly preferred embodiment, the inventive antifreeze/anticorrosion concentrates in each case additionally comprise up to 5% by weight, especially 0.5% to 3% by weight, of two different carboxylic acids from groups (a) and/or (b), and 0.05% to 5% by weight, especially 0.1% to 0.5% by weight, of one or more heterocycles from group (e).

These different carboxylic acids may, for example, be mixtures of an aliphatic monocarboxylic acid and an aliphatic dicarboxylic acid, of an aromatic monocarboxylic acid and an aliphatic dicarboxylic acid, of an aliphatic monocarboxylic acid and an aromatic monocarboxylic acid, of two aliphatic monocarboxylic acids or of two aliphatic dicarboxylic acids. Suitable heterocycles to be used additionally with preference here are in particular benzotriazole and tolutriazole.

The pH of the antifreeze concentrates of the invention is typically in the range from 4 to 11, preferably 5 to 10, more preferably 7 to 9.5 and especially 8.5 to 9.5. The desired pH may also optionally be established by addition of alkali metal hydroxide, ammonia or amines to the formulation; solid sodium hydroxide or potassium hydroxide and aqueous sodium hydroxide or potassium hydroxide solution are particularly suitable for this purpose.

Carboxylic acids to be used additionally with preference are appropriately added directly as the corresponding alkali metal salts in order to lie automatically within the desired pH range. However, the carboxylic acids can also be added in the form of free acids and then neutralized with alkali metal hydroxide, ammonia or amines, and the desired pH range can be established.

As further customary auxiliaries, the antifreeze/anticorrosion concentrate of the invention may also comprise, in customary small amounts, defoamers (generally in amounts of from 0.003 to 0.008% by weight) and, for reasons of hygiene and safety in the event that it is swallowed, bitter substances (for example of the denatonium benzoate type) and dyes.

Accordingly, the present invention further provides an antifreeze/anticorrosion concentrate comprising

1% to 10%, preferably 2% to 8% and more preferably 3% to 7% by weight, based on the total amount of the concentrate, of a mixture of
30-100% by weight of

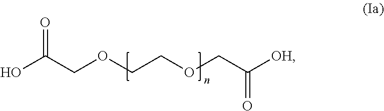

0-40% by weight of

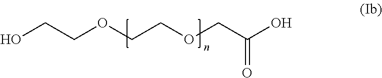

and
0-30% by weight of

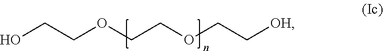

in which n is a positive integer from 1 to 5 and may be the same or different for each of the compounds (Ia), (Ib) and (Ic),
with the proviso that the sum total of the amounts of compounds (Ia), (Ib) and (Ic) in the mixture of (Ia), (Ib) and (Ic) is always 100% by weight,
0.01% to 5% by weight of at least one of the corrosion inhibitor compounds (a) to (g),
optionally at least one compound effective as a hard water stabilizer, defoamer or bitter substance, and
the difference from 100% by weight, based on the total amount of the concentrate, of at least one alcohol, preferably selected from the group consisting of ethylene glycol, 1,2-propylene glycol, diethylene glycol, dipropylene glycol, triethylene glycol, tetraethylene glycol, pentaethylene glycol, hexaethylene glycol, dipropylene glycol, tripropylene glycol, tetrapropylene glycol, pentapropylene glycol, hexapropylene glycol, 1,3-propylene glycol, glycerol, monomethyl-, -ethyl-, -propyl- and -butyl ethers of ethylene glycol, propylene glycol, diethylene glycol and dipropylene glycol, more preferably selected from the group consisting of ethylene glycol, diethylene glycol, propylene glycol, dipropylene glycol and glycerol, most preferably ethylene glycol, propylene glycol and glycerol and especially ethylene glycol.

The antifreeze/anticorrosion concentrates of the invention can be produced by simply mixing the individual components, preferably by stirring until a homogeneous mixture is attained.

The antifreezes are produced by mixing the antifreeze/anticorrosion concentrates of the invention with water in the desired ratio.

The present invention further provides a superconcentrate for an antifreeze/anticorrosive concentrate consisting of 5% to 40% by weight, based on the total amount of the superconcentrate, of a mixture of

30-100% by weight of

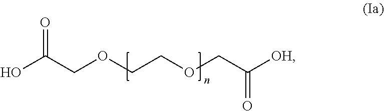

0-40% by weight of

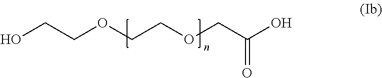

and
0-30% by weight of

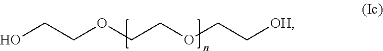

in which n is a positive integer from 1 to 5 and may be the same or different for each of the compounds (Ia), (Ib) and (Ic),
with the proviso that the sum total of the amounts of compounds (Ia), (Ib) and (Ic) in the mixture of (Ia), (Ib) and (Ic) is always 100% by weight,
0.05% to 30% by weight of at least one of the corrosion inhibitor compounds (a) to (g), and
optionally at least one compound effective as a hard water stabilizer, defoamer or bitter substance,
and additionally the difference from 100% by weight, based on the total amount of the concentrate, of at least one alcohol as antifreeze component, preferably selected from the group consisting of ethylene glycol, 1,2-propylene glycol, diethylene glycol, dipropylene glycol, triethylene glycol, tetraethylene glycol, pentaethylene glycol, hexaethylene glycol, dipropylene glycol, tripropylene glycol, tetrapropylene glycol, pentapropylene glycol, hexapropylene glycol, 1,3-propylene glycol, glycerol, monomethyl-, -ethyl-, -propyl- and -butyl ethers of ethylene glycol, propylene glycol, diethylene glycol and dipropylene glycol, more preferably selected from the group consisting of ethylene glycol, diethylene glycol, propylene glycol, dipropylene glycol and glycerol, most preferably ethylene glycol.

Accordingly, the present invention further provides a process for producing an antifreeze/anticorrosion concentrate, comprising the step of

mixing an antifreeze superconcentrate comprising a mixture of compound (Ia), optionally in combination with compound (Ib) and/or (Ic), with an alcohol as antifreeze component, where the proportion of the antifreeze component in the resulting mixture is 80% to 99% by weight based on the total amount of the mixture.

The weight ratio here of superconcentrate to antifreeze component is preferably in the range from 5:1 to 1:50. More preferably, this is in the range from 1:1 to 1:20.

The amount of antifreeze component in the superconcentrate is preferably at least 15% by weight, more preferably at least 20% by weight, based on the total amount. Water may be present as a further constituent.

The present invention also provides aqueous coolant compositions having a depressed freezing point, especially for radiator protection of internal combustion engines in the automobile sector, comprising water and 10% to 90% by weight, especially 20% to 60% by weight, of the antifreeze/anticorrosion concentrates of the invention. The water used for dilution should preferably be ion-free; it may be pure distilled or bidistilled water or, for example, water deionized by ion exchange.

The present invention further provides for use of coolant compositions of the invention in facilities where protection of water from frost (generally for the range from 0° C. to −40° C., in particular from −20° C. to −35° C.) and simultaneously protection of metal housings of vessels comprising water from corrosion are to be assured. Of particular interest here are the cooling circuits of internal combustion engines, especially in automobiles such as passenger vehicles and trucks. The coolant compositions of the invention may also be used in stationary engines, in hot water circuits of central heating systems, in resistance-heated radiators, in solar-powered circuits, but also in coolant-cooled circulation systems.

### EXAMPLES

The invention is elucidated in the examples which follow, but without restricting it thereto.

### SYNTHESIS EXAMPLES: COMPOUND (IA) FROM (IC)

### Gas Chromatography Analysis

The oxydiol (1) used in the examples and the reaction product obtained were each analyzed by gas chromatography for their organic components. The procedure for this purpose was as follows:
Gas chromatograph: Agilent 7890B
Column: Rxi-1 ms (length 30 m, 0.25 mm (ID), 0.25 μm (film)
Temperature program: 3 minutes at 60° C., heating from 60° C. to 290° C. at 5° C./min, 12 minutes at 290° C.
Sample preparation: The catalyst was filtered off and the water was removed. 50 mg of the anhydrous mixture were then mixed with 1 mL of MSTFA (N-methyl-N-(trimethylsilyl)trifluoroacetamide) and heated to 80° C. for 1 hour, and the sample is injected into the gas chromatograph.

### Example 1: 2.5 Mol % of Pt Based on (Ic)

200 g of pulverulent catalyst having 5% by weight of platinum on activated carbon, corresponding to 10 g or 0.0513 mol of Pt (source: Sigma-Aldrich), were charged into a 4 liter glass reactor and stirred together with 957 g of water at 1000 rpm. Subsequently, 410 g of oxydiol (I) with the distribution shown in the table below and an average molar mass of 200 g/mol were added, the mixture was equilibrated to 60° C., and 50 L/h of oxygen were passed through the reaction mixture with further stirring. The molar ratio of Pt to oxydiol (1) was thus 0.025, and the concentration of water in the liquid phase was 70% by weight. Since no base had been added, the initial pH was 6.9. After 27 hours, full conversion had been attained. The feed of oxygen was ended, and the reaction mixture was cooled down and discharged from the glass reactor. The reaction mixture had a pH of 1.5. It was filtered through a D4 glass freight and the filtercake was washed three times with 200 mL each time of warm water. The filtrate was then concentrated on a rotary evaporator at 45° C. at a pressure down to 10 mbar. 280 g of product mixture with the composition shown in the table below were obtained. The analyses of the organic components were each effected by gas chromatography. The water content was determined by Karl Fischer titration.

### Reactant Distribution (by Gas Chromatography):

| | (lc) | | | | | | | |
|---|---|---|---|---|---|---|---|---|
| | n = 0 | n = 1 | n = 2 | n = 3 | n = 4 | n = 5 | n = 6 | n = 7 |
| [GC | 4.9 | 23.9 | 31.0 | 22.1 | 11.2 | 4.5 | 1.4 | 0.3 |
| area%] | | | | | | | | |

### Product Distribution (by Gas Chromatography):

| (Ia) | n = 0 | n = 1 | n = 2 | n = 3 | n = 4 |
|---|---|---|---|---|---|
| [GC area %] | 26.6 | 31.1 | 24.7 | 11.3 | 1.9 |

| | |
|---|---|
| Glycolic acid | 4.5 |
| [GC area %] | |
| Water | 7 |
| [% by wt.] | |

The product (Ia) also contains 4.5 area % of hydroxyacetic acid.

### Example 2: 1 Mol % of Pt Based on (Ic)

78 g of pulverulent catalyst of the same type as in example 1, having 5% by weight of platinum on activated carbon, corresponding to 3.9 g or 0.020 mol of Pt (source: Sigma-Aldrich), were charged into a 4 liter glass reactor and stirred together with 957 g of water at 1000 rpm. Subsequently, analogous to example 1, 410 g of oxydiol (I) with the distribution shown in the table below and an average molar mass of 200 g/mol were added, the mixture was equilibrated to 60° C., and 50 L/h of oxygen were passed through the reaction mixture with further stirring. The molar ratio of Pt to oxydiol (I) was thus 0.0098, and the concentration of water in the liquid phase was 70% by weight. Since no base had been added, the initial pH was 6.9. After 67 hours, full conversion had been attained. The feed of oxygen was ended, and the reaction mixture was cooled down and discharged from the glass reactor. The reaction mixture likewise had a pH of 1.5. It was filtered through a D4 glass freight and the filtercake was washed three times with 200 mL each time of warm water. The filtrate was then concentrated on a rotary evaporator at 45° C. at a pressure down to 10 mbar. 436 g of product mixture with the composition shown in the table below were obtained. The analyses of the organic components were each effected by gas chromatography. The water content was determined by Karl Fischer titration.

### Reactant Distribution (by Gas Chromatography):

| | (lc) | | | | | | | |
|---|---|---|---|---|---|---|---|---|
| | n = 0 | n = 1 | n = 2 | n = 3 | n = 4 | n = 5 | n = 6 | n = 7 |
| [GC | 4.9 | 23.9 | 31.0 | 22.1 | 11.2 | 4.5 | 1.4 | 0.3 |
| area%] | | | | | | | | |

### Product Distribution (by Gas Chromatography):

| (Ia) | n = 0 | n = 1 | n = 2 | n = 3 | n = 4 |
|---|---|---|---|---|---|
| [GC area %] | 12.3 | 29.2 | 32.5 | 19.6 | 5.8 |

| | |
|---|---|
| Glycolic acid | 0.3 |
| [GC area %] | |
| Water | 4.9 |
| [% by wt.] | |

### Example 3

The catalyst was isolated by filtration at the end of the previous experiment and reused under the experimental conditions specified above. The results were comparable: 464 g of compound (Ia) were obtained with a product composition as follows:

| (Ia) | n = 0 | n = 1 | n = 2 | n = 3 | n = 4 |
|---|---|---|---|---|---|
| [GC area %] | 11.0 | 29.0 | 33.0 | 20.0 | 6.0 |

| | |
|---|---|
| Glycolic acid | 0.8 |
| [GC area %] | |
| Water | 6.8 |
| [% by wt.] | |

The results were also comparable in the case of another recovery and reuse. 467 g of compound (Ia) were obtained with a product distribution as follows:

| (Ia) | n = 0 | n = 1 | n = 2 | n = 3 | n = 4 |
|---|---|---|---|---|---|
| [GC area %] | 11.1 | 28.5 | 33.0 | 20.5 | 6.3 |

| | |
|---|---|
| Glycolic acid | 0.7 |
| [GC area %] | |
| Water | 7.3 |
| [% by wt.] | |

### Example 4: 2.5 Mol % of Pt Based on (Ic)

The catalyst (16 g) (Pt/C from Sigma-Aldrich, 10% by weight of platinum on activated carbon) was introduced into a 250 mL glass reactor and stirred together with 114 g of water at 1000 rpm. 49 g of compound (Ic) (n=1) (triethylene glycol from Sigma-Aldrich) were added, the mixture was equilibrated to 60° C. and 80 L/h of oxygen were passed through the reaction mixture. After 21 hours, full conversion was attained, and the mixture was cooled down, discharged and filtered through a D4 glass suction filter. The filtercake was washed with 300 mL of warm water in each case. The filtrate was concentrated on a rotary evaporator at 45° C. at a pressure down to 10 mbar. 48 g of compound (Ia) (n=1) were obtained.

### USE EXAMPLES

The corrosion tests which follow were conducted to ASTM D 4340. This standard test serves to determine the propensity of aluminum or aluminum alloys to corrosion in cooling devices for internal combustion engines. The standard apparatus used for this purpose simulates the aluminum-containing hot internal surface of a cooling circuit of an internal combustion engine. An aluminum test plate is heated from below while it is in contact with the cooling fluid to be tested. The test temperature is 135° C. On conclusion of the test, after the fixed test duration of 168 hours, the plate is assessed visually for corrosion and the change in weight is determined by weighing. Removal of material by corrosion is determined in accordance with ASTM D1384 to be 33% in dilution with water.

### Composition of the Test Fluids

| Feedstocks | Fluid 1 | Fluid 2 | Fluid 3 |
|---|---|---|---|
| Monoethylene glycol | 90.96 | | |
| Other inhibitors (total) | 0.95 | | |
| Phosphoric acid (75% | 0.15 | | |
| by weight in water) | | | |
| Sebacic acid | 3.0 | | |
| Triethylene glycol diacid | | 3.0 | |
| (formula (Ia), n = 1) from | | | |
| example 4 | | | |
| Polyethylene glycol | | | 3.0 |
| diacid (formula (Ia), n = | | | |
| 2) from example 2 | | | |

| | |
|---|---|
| Tolutriazole | 0.15 |
| Commercial silicate | 400 ppm by weight |
| Standard hard water | 0.15 |
| stabilizer | |
| Denatonium benzoate | 0.01 |
| Standard defoamer | 0.01 |
| Potassium hydroxide | 4.19 |
| (48% by weight in water) | |

The additions, by contrast, resulted in the following physical data in accordance with ASTM D1384 (without aqueous dilution with ASTM water to 33% by volume):

| | Fluid 1 | Fluid 2 | Fluid 3 |
|---|---|---|---|
| pH, before test | 8.2 | 8.21 | 10.12 |
| pH, after test | 7.7 | 7.16 | 8.78 |

The following corrosion rates were determined to ASTM 4340 (specific change in mass with etching blank mg/cm²):

| | Fluid 1 | Fluid 2 | Fluid 3 |
|---|---|---|---|
| Copper F-CU | 0.05 | −0.08 | −0.08 |
| Soft solder L - PbSn30 BASF | 0.12 | −0.11 | −0.17 |
| Brass Ms - 63 | 0.08 | −0.14 | −0.14 |
| Steel H - II | 0.01 | 0.00 | −0.08 |
| Gray cast iron GG - 25 | 0.02 | 0.04 | −0.02 |
| Cast aluminum G - AlSi6Cu4 | 0.1 | −0.13 | −0.13 |

1. An antifreeze/anticorrosive concentrate, comprising 1% to 10% by weight, based on a total amount of the concentrate, of a mixture of
30-100% by weight of 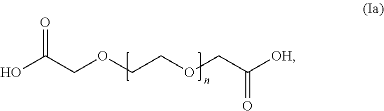
0-40% by weight of 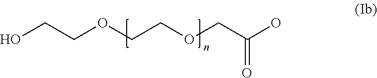
and
0-30% by weight of 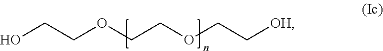
wherein n is a positive integer from 1 to 5 and may be the same or different for each of (Ia), (Ib) and (Ic),
with the proviso that a sum total of the amounts of (Ia), (Ib) and (Ic) in the mixture is always 100% by weight.

2. The antifreeze/anticorrosive concentrate of claim 1, comprising 2% to 8% by weight, based on the total amount of the concentrate, of the mixture.

3. The antifreeze/anticorrosive concentrate of claim 1, wherein n is a positive integer from 1 to 4.

4. The antifreeze/anticorrosive concentrate of claim 1, further comprising at least one of the following:
(a) up to 5% by weight of one or more alkali metal, ammonium or substituted ammonium salt of an aliphatic, cycloaliphatic or aromatic monocarboxylic acid having 3 to 16 carbon atoms;
(b) up to 5% by weight of one or more alkali metal, ammonium or substituted ammonium salt of an aliphatic or aromatic di- or tricarboxylic acid having 3 to 21 carbon atoms;
(c) up to 1% by weight of one or more alkali metal borates, alkali metal phosphates, alkali metal silicates, alkali metal nitrites, alkali metal or alkaline earth metal nitrates, alkali metal molybdates or alkali metal or alkaline earth metal fluorides;
(d) up to 5% by weight of one or more aliphatic, cycloaliphatic or aromatic amines which have 2 to 15 carbon atoms and may additionally comprise ether oxygen atoms or hydroxyl groups;
(e) up to 5% by weight of one or more mono- or polycyclic, unsaturated or partly unsaturated heterocycles which have 4 to 10 carbon atoms and may be benzofused and/or may bear additional functional groups;
(f) up to 5% by weight of one or more tetra(C₁-C₈-alkoxy)silanes (tetra-C₁-C₈-alkyl orthosilicates);
(g) up to 10% by weight of one or more carboxamides or sulfonamides;
(h) up to 1% by weight of one or more hard water stabilizers based on polyacrylic acid, polymaleic acid, acrylic acid-maleic acid copolymers, polyvinylpyrrolidone, polyvinylimidazole, vinylpyrrolidone-vinylimidazole copolymers and/or copolymers of unsaturated carboxylic acids and olefins,
wherein each amount is based on the total amount of the concentrate.

5. The antifreeze/anticorrosive concentrate of claim 1, comprising, in addition to the mixture, 0.01% to 5% by weight, based on the total amount of the concentrate, of at least one corrosion inhibitor.

6. The antifreeze/anticorrosive concentrate of claim 1, wherein a pH of the concentrate is in a range of from 4 to 11.

7. An antifreeze/anticorrosive concentrate, comprising
1% to 10%, based on a total amount of the concentrate, of a mixture of
30-100% by weight of 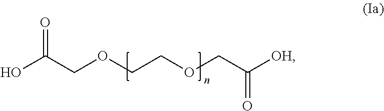
0-40% by weight of 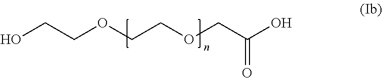
and
0-30% by weight of 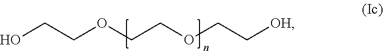
wherein n is a positive integer from 1 to 5 and may be the same or different for each of (Ia), (Ib) and (Ic),
with the proviso that a sum total of the amounts of (Ia), (Ib) and (Ic) in the mixture is always 100% by weight,
0.01% to 5% by weight of at least one of the following corrosion inhibitor compounds (a) to (g);
(a) one or more alkali metal, ammonium or substituted ammonium salt of an aliphatic, cycloaliphatic or aromatic monocarboxylic acid having 3 to 16 carbon atoms;
(b) one or more alkali metal, ammonium or substituted ammonium salt of an aliphatic or aromatic di- or tricarboxylic acid having 3 to 21 carbon atoms;
(c) one or more alkali metal borates, alkali metal phosphates, alkali metal silicates, alkali metal nitrites, alkali metal or alkaline earth metal nitrates, alkali metal molybdates or alkali metal or alkaline earth metal fluorides;
(d) one or more aliphatic, cycloaliphatic or aromatic amines which have 2 to 15 carbon atoms and may additionally comprise ether oxygen atoms or hydroxyl groups;
(e) one or more mono- or polycyclic, unsaturated or partly unsaturated heterocycles which have 4 to 10 carbon atoms and may be benzofused and/or may bear additional functional groups;
(f) one or more tetra(C₁-C₈-alkoxy)silanes (tetra-C₁-C₈-alkyl orthosilicates);
(g) one or more carboxamides or sulfonamides;
optionally at least one compound effective as a hard water stabilizer, defoamer or bitter substance, and
the difference from 100% by weight, based on the total amount of the concentrate, of at least one alcohol.

8. The antifreeze/anticorrosive concentrate of claim 1, additionally comprising 0.01% to 5% by weight, based on the total amount of the concentrate, of at least one corrosion inhibitor other than (Ia), (Ib) and (Ic).

9. The antifreeze/anticorrosive concentrate of claim 1, consisting of the mixture,
0.01% to 5% by weight, based on the total amount of the concentrate, of at least one corrosion inhibitor other than (Ia), (Ib) and (Ic),
optionally one or more further typical ingredients of antifreeze/anticorrosive concentrates, and
the difference from 100% by weight, based on the total amount of the concentrate, of at least one alcohol as an antifreeze component.

10. A superconcentrate for an antifreeze/anticorrosive concentrate, consisting of 5% to 40% by weight, based on a total amount of the superconcentrate, of a mixture of
30-100% by weight of 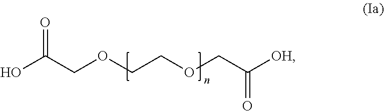
0-40% by weight of 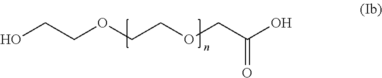
and
0-30% by weight of 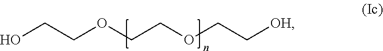
wherein n is a positive integer from 1 to 5 and may be the same or different for each of (Ia), (Ib) and (Ic),
with the proviso that a sum total of the amounts of (Ia), (Ib) and (Ic) in the mixture is always 100% by weight;
0.05% to 30% by weight of at least one of the following corrosion inhibitor compounds (a) to (g):
(a) one or more alkali metal, ammonium or substituted ammonium salt of an aliphatic, cycloaliphatic or aromatic monocarboxylic acid having 3 to 16 carbon atoms;
(b) one or more alkali metal, ammonium or substituted ammonium salt of an aliphatic or aromatic di- or tricarboxylic acid having 3 to 21 carbon atoms;
(c) one or more alkali metal borates, alkali metal phosphates, alkali metal silicates, alkali metal nitrites, alkali metal or alkaline earth metal nitrates, alkali metal molybdates or alkali metal or alkaline earth metal fluorides;
(d) one or more aliphatic, cycloaliphatic or aromatic amines which have 2 to 15 carbon atoms and may additionally comprise ether oxygen atoms or hydroxyl groups;
(e) one or more mono- or polycyclic, unsaturated or partly unsaturated heterocycles which have 4 to 10 carbon atoms and may be benzofused and/or may bear additional functional groups;
(f) one or more tetra(C₁-C₈-alkoxy)silanes (tetra-C₁-C₈-alkyl orthosilicates);
(g) one or more carboxamides or sulfonamides; and
optionally at least one compound effective as a hard water stabilizer, defoamer or bitter substance.

11. A process for producing an antifreeze/anticorrosive concentrate, the process comprising mixing the antifreeze superconcentrate of claim 10 with an antifreeze component selected from the group consisting of ethylene glycol, 1,2-propylene glycol, diethylene glycol, dipropylene glycol, triethylene glycol, tetraethylene glycol, pentaethylene glycol, hexaethylene glycol, dipropylene glycol, tripropylene glycol, tetrapropylene glycol, pentapropylene glycol, hexapropylene glycol, 1,3-propylene glycol, glycerol, monomethyl-, -ethyl-, -propyl- and -butyl ethers of ethylene glycol, propylene glycol, diethylene glycol and dipropylene glycol, to obtain a mixture,
wherein an amount of the antifreeze component in the mixture is 10% to 50% by weight, based on a total amount of the mixture.

12. An aqueous coolant composition, comprising 10% to 90% by weight of the antifreeze/anticorrosive concentrate of claim 1.

13. A process for producing a coolant composition, the process comprising mixing the antifreeze/anticorrosive concentrate of claim 1 with water.

14. A process of protecting water from frost and simultaneously protecting a metal housing of a vessel comprising water from corrosion, the process comprising contacting the water and/or metal housing with the coolant composition of claim 12.
